(19) United States
(12) Patent Application Publication
(10) Pub. No.: US 2017/0018816 A1
(43) Pub. Date: Jan. 19, 2017

(54) POLYMER BATTERY CELL AND ELECTRONIC DEVICE COMPRISING SAME

(71) Applicant: ITM SEMICONDUCTOR CO., LTD., Chungcheongbuk-do (KR)

(72) Inventors: Hyeokhwi NA, Chungcheongbuk-do (KR); Hoseok HWANG, Gyeonggi-do (KR); Youngseok KIM, Chungcheongbuk-do (KR); Sanghoon AHN, Chungcheongbuk-do (KR); Seunguk PARK, Chungcheongnam-do (KR); Jaeku PARK, Chungcheongbuk-do (KR); Younggeun YOON, Chungcheongbuk-do (KR); Hyunsuck LEE, Chungcheongbuk-do (KR); Sunghee WANG, Jeollanam-do (KR); Jihyun HONG, Gyeongsangnam-do (KR); Jiseon BAEK, Seoul (KR); Euihyeok LIM, Chungcheongbuk-do (KR)

(21) Appl. No.: 15/124,153

(22) PCT Filed: Mar. 31, 2015
(86) PCT No.: PCT/KR2015/003150

§ 371 Date: Sep. 7, 2016

(30) Foreign Application Priority Data
Apr. 17, 2014 (KR) 10-2014-0046024

(51) Int. Cl. H01M 10/42; H01M 10/04; H01M 2/02; H01M 2/34

(52) U.S. Cl. CPC H01M 10/4257; H01M 2/348; H01M 10/0431; H01M 2/0275; H01M 2200/106

(57) ABSTRACT

Disclosed are a polymer battery cell capable of increasing cell capacity due to efficient use of space by efficiently placing a protection circuit device, and thus of effectively protecting the protection circuit device from an external environment, and an electronic device including the polymer battery cell. The polymer battery cell includes an electrode body including a positive plate, a negative plate, and a separator provided between the positive and negative plates, cell taps including a positive tap connected to and protruding from the positive plate, and a negative tap connected to and protruding from the negative plate, and a battery protection circuit module electrically connected to the cell taps. The polymer battery cell further includes a pouch receiving the electrode body, the cell taps, and the battery protection circuit module therein, and being made of a flexible material.

### TECHNICAL FIELD

The present invention relates to a polymer battery cell and an electronic device including the same and, more particularly, to a polymer battery cell including a battery protection circuit module, and an electronic device including the polymer battery cell.

### BACKGROUND ART

Unlike non-rechargeable primary batteries, secondary batteries are rechargeable. The secondary batteries are used as energy sources in small mobile devices such as cellular phones, laptop computers, and camcorders, and medium and large devices such as electric vehicles, hybrid electric vehicles, electric bikes, and uninterruptible power supply devices.

Representative secondary batteries include lithium secondary batteries. The lithium secondary batteries may be divided into can-type secondary batteries having a cylindrical or hexagonal shape according to the shape of a case accommodating an electrode assembly therein, and pouch-type secondary batteries having flexibility. The secondary batteries may be classified into liquid electrolyte batteries and polymer electrolyte batteries depending on the type of an electrolyte. In general, batteries using a liquid electrolyte are called lithium ion polymer batteries, and batteries using a polymer electrolyte are called lithium polymer batteries.

Like the lithium ion polymer batteries, the lithium polymer batteries have a degradation in performance and a risk of explosion if the batteries are heated and thus the temperature thereof is increased due to overcharge, overdischarge, and overcurrent. As such, the lithium polymer batteries may include a protection circuit device for detecting overcharge, overdischarge, and overcurrent and stopping battery operation.

### DETAILED DESCRIPTION OF THE INVENTION

### Technical Problem

However, in a polymer battery cell including a protection circuit device, and an electronic device including the polymer battery cell, the efficiency of using a device space may be reduced due to the protection circuit device and the protection circuit device may be easily damaged by external impact. The present invention provides a polymer battery cell capable of increasing cell capacity due to efficient use of space by efficiently placing a protection circuit device, and thus of effectively protecting the protection circuit device from an external environment, and an electronic device including the polymer battery cell. However, the scope of the present invention is not limited thereto.

### Technical Solution

According to an aspect of the present invention, there is provided a polymer battery cell including an electrode body including a positive plate, a negative plate, and a separator provided between the positive and negative plates, cell taps including a positive tap connected to and protruding from the positive plate, and a negative tap connected to and protruding from the negative plate, a battery protection circuit module electrically connected to the cell taps, and a pouch receiving the electrode body, the cell taps, and the battery protection circuit module therein, and being made of a flexible material.

The electrode body, the cell taps, and the battery protection circuit module may not be exposed outside the pouch and may be accommodated in the pouch.

The battery protection circuit module may be provided in a recess of the electrode body.

The battery protection circuit module may be provided at an upper part of the electrode body, and a level of an area of the electrode body where the battery protection circuit module is not mounted may be higher than a level of an area where the battery protection circuit module is mounted.

The battery protection circuit module may include a lead frame including a plurality of leads spaced apart from each other, and bonded and electrically connected to the cell taps, battery protection circuit elements mounted on the lead frame and including a protection integrated circuit (IC), field effect transistors (FETs), and passive elements, and an encapsulant for encapsulating the battery protection circuit elements to expose a part of the lead frame.

The lead frame may include a first internal connection terminal lead and a second internal connection terminal lead provided at two edges, exposed by the encapsulant, and electrically connected to the positive and negative taps, respectively, external connection terminal leads provided between the first and second internal connection terminal leads and serving as a plurality of external connection terminals, and element mounting leads provided between the first and second internal connection terminal leads and used to mount the battery protection circuit elements thereon.

The first internal connection terminal lead may be folded and thus two parts thereof may be bonded to each other in such a manner that the positive tap is provided between the two parts, and the second internal connection terminal lead may be folded and thus two parts thereof may be bonded to each other in such a manner that the negative tap is provided between the two parts.

The battery protection circuit module may include a printed circuit board (PCB), battery protection circuit elements mounted on the PCB and including a protection IC, FETs, and passive elements, and an encapsulant for encapsulating the battery protection circuit elements.

The polymer battery cell may further include a flexible printed circuit board (FPCB) having an end bonded and electrically connected to the battery protection circuit module, and another end for exposing a conductive terminal, and the conductive terminal may be exposed outside the pouch.

According to an aspect of the present invention, there is provided an electronic device including an electrode body including a positive plate, a negative plate, and a separator provided between the positive and negative plates, cell taps including a positive tap connected to and protruding from the positive plate, and a negative tap connected to and protruding from the negative plate, a battery protection circuit module electrically connected to the cell taps, a pouch used to accommodate the electrode body, the cell taps, and the battery protection circuit module therein, and made of a flexible material, a flexible printed circuit board (FPCB) having an end bonded and electrically connected to the battery protection circuit module, and another end for exposing a conductive terminal, and a main board directly and electrically connected to the conductive terminal.

### Advantageous Effects

According to some embodiments of the present invention, a polymer battery cell capable of increasing cell capacity due to efficient use of space by efficiently placing a protection circuit device, and thus of effectively protecting the protection circuit device from an external environment, and an electronic device including the polymer battery cell may be provided. However, the scope of the present invention is not limited to the above-described effect.

### DESCRIPTION OF THE DRAWINGS

FIG. 1 is an exploded perspective view of a polymer battery cell according to an embodiment of the present invention.

FIG. 2 is a plan view of the polymer battery cell according to an embodiment of the present invention.

FIG. 3A is a plan view of a part of the polymer battery cell, according to an embodiment of the present invention.

FIG. 3B is a plan view of a part of the polymer battery cell, according to another embodiment of the present invention.

FIG. 4 is a perspective view of a part of an electronic device according to an embodiment of the present invention.

FIG. 5 is a circuit diagram of a battery protection circuit included in a battery protection circuit module of the polymer battery cell, according to an embodiment of the present invention.

FIG. 6 is a perspective view showing the structure of a lead frame and battery protection circuit elements included in the battery protection circuit module of the polymer battery cell, according to an embodiment of the present invention.

FIGS. 7A and 7B are perspective views showing that internal connection terminal leads included in the battery protection circuit module of the polymer battery cell are folded, according to an embodiment of the present invention.

FIG. 8 is a perspective view of a battery protection circuit module assembly included in the polymer battery cell, according to an embodiment of the present invention.

FIG. 9 is a perspective view showing that the internal connection terminal leads included in the battery protection circuit module of the polymer battery cell are folded and bonded to cell taps, according to an embodiment of the present invention.

### BEST MODE

Hereinafter, the present invention will be described in detail by explaining embodiments of the invention with reference to the attached drawings.

The invention may, however, be embodied in many different forms and should not be construed as being limited to the embodiments set forth herein; rather, these embodiments are provided so that this disclosure will be thorough and complete, and will fully convey the concept of the invention to one of ordinary skill in the art. In the drawings, the thicknesses or sizes of layers are exaggerated for clarity.

It will be understood that when an element, such as a layer, a region, or a substrate, is referred to as being “on,” “connected to” or “coupled to” another element, it may be directly on, connected or coupled to the other element or intervening elements may be present. In contrast, when an element is referred to as being “directly on,” “directly connected to” or “directly coupled to” another element or layer, there are no intervening elements or layers present. Like reference numerals refer to like elements throughout. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of embodiments.

Spatially relative terms, such as “above,” “upper,” “beneath,” “below,” “lower,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “above” may encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of embodiments. As used herein, the singular forms “a,” “an” and “the” are intended to include the plural forms as well, unless the context clearly indicates otherwise. It will be further understood that the terms “comprises” and/or “comprising” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to schematic illustrations of idealized embodiments (and intermediate structures) of the invention. As such, variations from the shapes of the illustrations as a result, for example, of manufacturing techniques and/or tolerances, are to be expected. Thus, the embodiments of the invention should not be construed as limited to the particular shapes of regions illustrated herein, but are to include deviations in shapes that result, for example, from manufacturing.

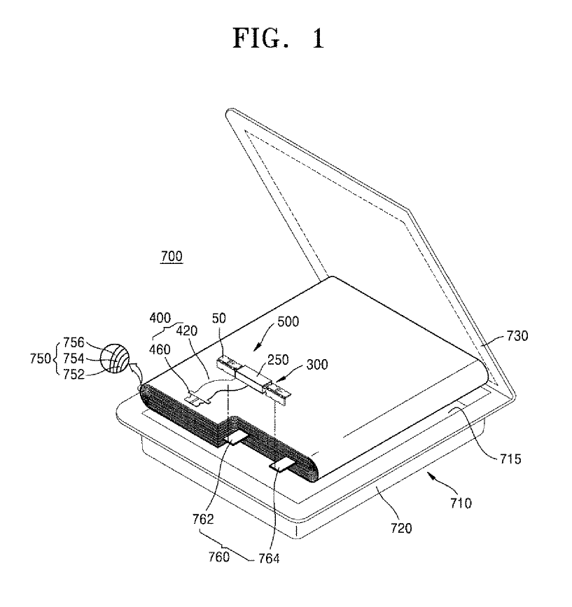

FIG. 1 is an exploded perspective view of a polymer battery cell 700 according to an embodiment of the present invention.

Referring to FIG. 1, the polymer battery cell 700 according to an embodiment of the present invention includes an electrode body 750, cell taps 760, a battery protection circuit module 300, and a pouch 710.

The electrode body 750 may include a negative plate 752, a positive plate 756, and a separator 754 provided between the negative plate 752 and the positive plate 756. The separator 754 may include a polymer electrolyte. A structure of the negative plate 752, the separator 754, and the positive plate 756 may be stacked on one or more other structures thereof.

The cell taps 760 are electrically connected to the electrode body 750, and include a negative tap 764 and a positive tap 762. The negative tap 764 is electrically connected to the negative plate 752 and protrudes from the electrode body 750, and the positive tap 762 is electrically connected to the positive plate 756 and protrudes from the electrode body 750. The configuration of the negative and positive taps 764 and 762 illustrated in FIG. 1 does not limit the technical idea of the present invention, and is variable depending on product specifications. For example, the positions of the negative and positive taps 764 and 762 may be switched. Optionally, at least parts of the negative and positive taps 764 and 762 may be wound by insulation tape.

The battery protection circuit module 300 electrically connected to the cell taps 760 is a protection circuit device for detecting overcharge, overdischarge, and overcurrent and stopping battery operation, and may be understood as an arbitrary structure including a protection integrated circuit (IC), field effect transistors (FETs), and passive elements. For example, battery protection circuit elements of the battery protection circuit module 300, e.g., the protection IC, the FETs, and the passive elements, may be mounted on a lead frame. As another example, battery protection circuit elements of the battery protection circuit module 300, e.g., the protection IC, the FETs, and the passive elements, may be mounted on a printed circuit board (PCB), and the PCB may be connected to a lead frame.

A flexible printed circuit board (FPCB) 400 may be connected to a side of the battery protection circuit module 300. The FPCB 400 includes a resin part 420 having flexibility, and a conductive terminal 460 provided at an end of the FPCB 400. An end of the FPCB 400 is bonded and electrically connected to the battery protection circuit module 300, and another end thereof exposes the conductive terminal 460. In this specification, the battery protection circuit module 300 to which the FPCB 400 is bonded may be called a battery protection circuit module assembly 500.

The pouch 710 is made of a flexible material. For example, the pouch 710 may be understood as a flexible material case and may not be a hard metal case. The pouch 710 may be implemented as, for example, metal foil or a multilayer structure including an insulation film provided at least one of two surfaces of metal foil, but is not limited thereto.

The pouch 710 includes an upper case 730 and a lower case 720 bonded to the upper case 730. At least parts of surfaces of the upper case 730 and the lower case 720 may be integrally bonded to each other. The lower case 720 has an internal space 715 capable of accommodating all of the above-described electrode body 750, the cell taps 760, and the battery protection circuit module 300 therein.

To describe that the pouch 710 has the internal space 715 capable of accommodating all of the electrode body 750, the cell taps 760, and the battery protection circuit module 300 therein, the upper case 730 and the lower case 720 are separately illustrated and the lower case 720 has the internal space 715 in FIG. 1. However, the technical idea of the present invention is not limited thereto.

For example, the pouch 710 may include the upper case 730 having a first space and the lower case 720 having a second space, and all of the electrode body 750, the cell taps 760, and the battery protection circuit module 300 may be accommodated in the internal space 715 including the first space and the second space.

As another example, the pouch 710 may be provided as one body made of a flexible material, and may be implemented by wrapping the electrode body 750, the cell taps 760, and the battery protection circuit module 300 and then sealing an opening.

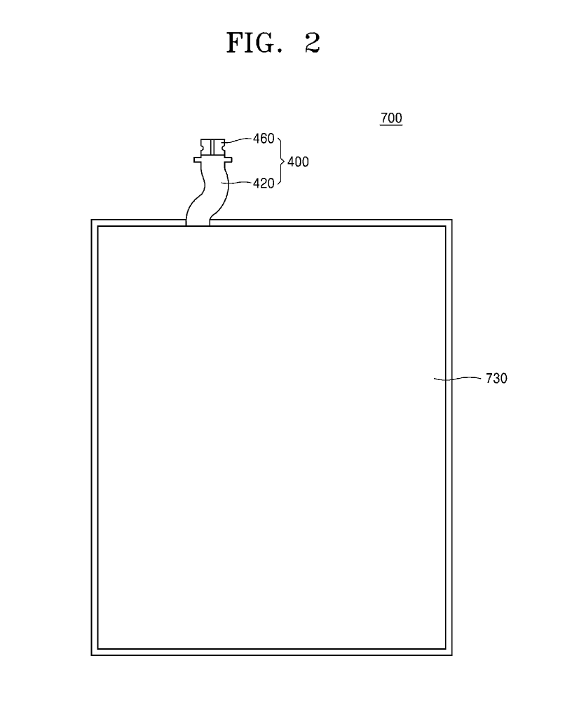

FIG. 2 is a plan view of the polymer battery cell 700 according to an embodiment of the present invention. FIG. 2 illustrates the pouch 710 implemented by placing all of the electrode body 750, the cell taps 760, and the battery protection circuit module 300 to be accommodated in the internal space 715 of the pouch 710 and then integrally bonding the upper case 730 to the lower case 720.

Referring to FIGS. 1 and 2, in the polymer battery cell 700 according to an embodiment of the present invention, the electrode body 750, the cell taps 760, and the battery protection circuit module 300 are not exposed outside the pouch 710 and are accommodated therein. That is, the positive and negative taps 762 and 764 included in the cell taps 760 are provided only in the internal space 715 and are not exposed outside the pouch 710. The battery protection circuit module 300 is also provided only in the internal space 715 and is not exposed outside the pouch 710.

However, in the polymer battery cell 700 according to an embodiment of the present invention, at least a part of the resin part 420 and the conductive terminal 460 included in the FPCB 400 connected to the battery protection circuit module 300 are not provided in the internal space 715 of the pouch 710 and are exposed outside the pouch 710.

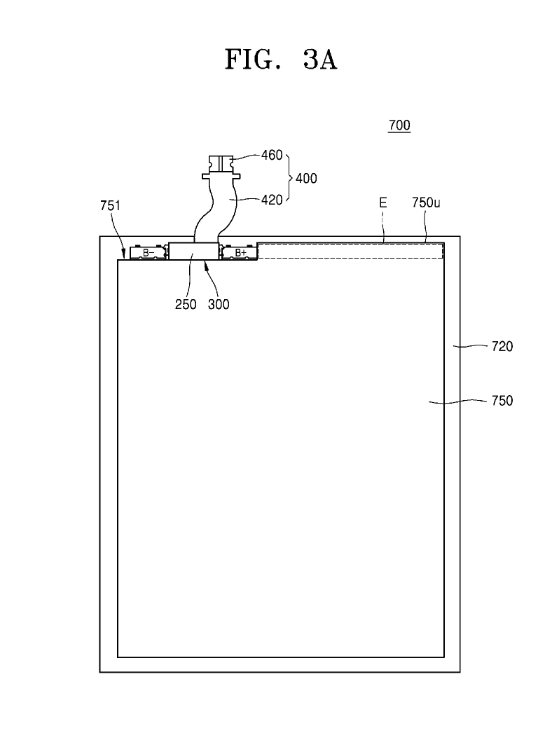

FIG. 3A is a plan view of a part of the polymer battery cell 700, according to an embodiment of the present invention. FIG. 3A illustrates a configuration in which all of the electrode body 750, the cell taps 760, and the battery protection circuit module 300 are accommodated in the internal space 715 of the pouch 710 before the upper case 730 is bonded to the lower case 720.

Referring to FIGS. 1 and 3A, in the polymer battery cell 700 according to an embodiment of the present invention, the battery protection circuit module 300 is provided in the internal space 715 of the pouch 710. Since the battery protection circuit module 300 is accommodated in the pouch 710 and is not exposed outside the pouch 710, the battery protection circuit module 300 may be protected from an external environment.

In addition, since the electrode body 750 uses an extra space E generated after the battery protection circuit module 300 is accommodated inside, cell capacity may be increased due to efficient use of space. In another point of view, the battery protection circuit module 300 may be provided in a recess 751 of the electrode body 750. That is, the battery protection circuit module 300 may be provided at an upper part 750u of the electrode body 750, and a level of an area of the electrode body 750 where the battery protection circuit module 300 is not mounted may be higher than the level of an area where the battery protection circuit module 300 is mounted.

FIG. 3B is a plan view of a part of the polymer battery cell 700, according to another embodiment of the present invention. FIG. 3B illustrates a modified configuration in which all of the electrode body 750, the cell taps 760, and the battery protection circuit module 300 are accommodated in the internal space 715 of the pouch 710 before the upper case 730 is bonded to the lower case 720.

Although the battery protection circuit module 300 is provided at a side of the upper part 750u of the electrode body 750 in FIG. 3A, the battery protection circuit module 300 may be provided at the center of the upper part 750u of the electrode body 750 in FIG. 3B. In this case, a pair of extra spaces E are generated at two sides of the battery protection circuit module 300 after the battery protection circuit module 300 is accommodated inside. Since the electrode body 750 uses the extra spaces E, cell capacity may be increased due to efficient use of space.

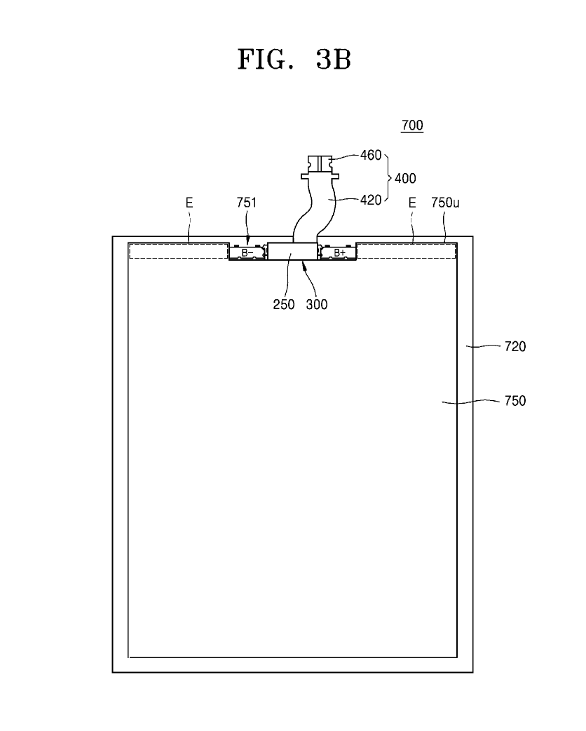

FIG. 4 is a perspective view of a part of an electronic device 900 according to an embodiment of the present invention.

Referring to FIGS. 1 and 4, the electronic device 900 according to an embodiment of the present invention includes the above-described electrode body 750, the cell taps 760, the battery protection circuit module 300, the pouch 710, and the FPCB 400. The electronic device 900 according to an embodiment of the present invention further includes a main board 880 directly and electrically connected to the conductive terminal 460 of the FPCB 400.

The main board 880 may include a main board of an electronic device (e.g., a smartphone, a mobile phone, a smartpad, or a tablet computer) electrically connected to the polymer battery cell 700 to receive power from or supply power to the polymer battery cell 700.

For direct and electrical connection between the conductive terminal 460 and the main board 880, the main board 880 may include a housing 884 having a space capable of accommodating the conductive terminal 460 of the FPCB 400 therein, and the housing 884 may include a holder 886 for holding the conductive terminal 460 of the FPCB 400 inserted into the space.

Specifically, when the holder 886 of the housing 884 is open, the conductive terminal 460 provided at an end of the FPCB 400 may be inserted into the space of the housing 884. Subsequently, the holder 886 of the housing 884 may be closed to hold the conductive terminal 460 provided at an end of the FPCB 400 and inserted into the space of the housing 884.

Unlike FIG. 4, in the electronic device 900 according to a modified embodiment of the present invention, the conductive terminal 460 provided at an end of the FPCB 400 may be electrically connected to the main board 880 not in a direct manner but by providing a connector therebetween.

A description is now given of configurations of the battery protection circuit module 300 and the battery protection circuit module assembly 500 accommodated in the pouch 710.

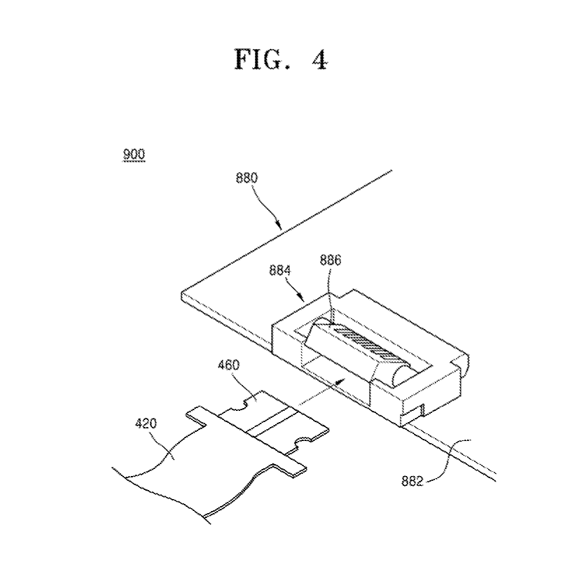

FIG. 5 is a circuit diagram of a battery protection circuit 10 included in the battery protection circuit module 300 of the polymer battery cell 700, according to an embodiment of the present invention.

As illustrated in FIGS. 1 and 5, the battery protection circuit 10 included in the battery protection circuit module 300 of the polymer battery cell 700, according to an embodiment of the present invention includes first and second internal connection terminals B+ and B− to be connected to the polymer battery cell 700, and first to third external connection terminals P+, TH, and P− to be connected to a charger for charging and to be connected to an electronic device (e.g., a mobile device) operating by battery power, for discharging. Herein, among the first to third external connection terminals P+, TH, and P−, the first and third external connection terminals P+ and P− are used for power supply and the second external connection terminal TH is used to detect a battery type and perform charging appropriately for the battery type. In addition, the second external connection terminal TH may be provided as a thermistor for detecting battery temperature when charging, and is used as a terminal having another function.

The battery protection circuit 10 may have a connection structure of a dual FET chip 110, a protection IC 120, resistors R1, R2, and R3, a varistor V1, and capacitors C1 and C2. The dual FET chip 110 includes a first FET FET1 and a second FET FET2 having a common drain structure. The protection IC 120 has a terminal (e.g., VDD) connected through the resistor R1 to the first internal connection terminal B+ serving as a positive (+) terminal of a battery, applying a charge or discharge voltage through a first node n1, and detecting a battery voltage, a reference terminal (e.g., VSS) for providing a reference voltage of an internal operation voltage of the protection IC 120, a detection terminal (e.g., V−) for detecting charge/discharge and overcurrent states, a discharge off signal output terminal (e.g., DO) for switching off the first FET FET1 in an overdischarge state, and a charge off signal output terminal (e.g., CO) for switching off the second FET FET2 in an overcharge state.

In this case, the protection IC 120 includes a reference voltage setter, a comparer for comparing a reference voltage and a charge/discharge voltage to each other, an overcurrent detector, and a charge/discharge detector. Herein, reference voltages for determining the charge and discharge states may be changed depending on specifications required by a user, and the charge and discharge states are determined based on the reference voltages by detecting the voltage difference between terminals of the protection IC 120.

The protection IC 120 is configured in such a manner that the terminal DO is changed to a LOW state to switch off the first FET FET1 in an overdischarge state, that the terminal CO is changed to a LOW state to switch off the second FET FET2 in an overcharge state, and that the second FET FET2 is switched off when charging and the first FET FET1 is switched off when discharging in overcurrent state.

The resistor R1 and the capacitor C1 stabilize variations in power supply of the protection IC 120. The resistor R1 is connected between the first node n1 serving as a power (V1) supply node of the battery, and the terminal VDD of the protection IC 120, and the capacitor C1 is connected between the terminal VDD and the terminal VSS of the protection IC 120. Herein, the first node n1 is connected to the first internal connection terminal B+and the first external connection terminal P+. If the resistor R1 has a high value, when a voltage is detected, the detected voltage is increased due to a current flowing into the protection IC 120. As such, the value of the resistor R1 is set to an appropriate value equal to or less than 1 KΩ. In addition, for stable operation, the capacitor C1 may have an appropriate value equal to or greater than 0.01 μF, for example, 0.1 μF.

The resistors R1 and R2 serve as a current limiter if a charger provides a high voltage exceeding absolute maximum ratings of the protection IC 120 or if the charger is connected with wrong polarity. The resistor R2 is connected between the terminal V− of the protection IC 120 and a second node n2 connected to a source terminal S2 of the second FET FET2. Since the resistors R1 and R2 are closely related to power consumption, a sum of the values of the resistors R1 and R2 is set to be greater than 1 KΩ. In addition, since recovery may not occur after overcharge off operation if the value of the resistor R2 is excessively large, the value of the resistor R2 is set to a value equal to or less than 10 KΩ. For example, the resistor R1 may have a value of 1 KΩ and the resistor R2 may have a value of 2.2 KΩ.

The capacitor C2 is connected between the second node n2 (or the third external connection terminal P−) and a source terminal S1 of the first FET FET1 (or the terminal VSS). The capacitor C2 does not exert a strong influence on the features of a battery protection circuit product, but is added upon a request of the user or for stability. The capacitor C2 is used to achieve system stabilization by improving tolerance to voltage variations or external noise. For stable operation, the capacitor C2 may have a value of, for example, 0.1 μF.

The resistor R3 and the varistor V1 are elements for electrostatic discharge (ESD) and surge protection, and are connected in parallel to each other between the second external connection terminal TH and the second node n2 (or the third external connection terminal P−). The varistor V1 is an element for reducing a resistance thereof when overvoltage occurs, and may minimize, for example, circuit damage due to overvoltage.

As a safety device for preventing battery rupture, a positive temperature coefficient (PTC) structure PTC may be provided between the second internal connection terminal B− and the capacitors C1 and C2. For example, although a PTC structure serves as a current path at a predetermined temperature or below, if overcurrent occurs and thus the temperature is increased above the predetermined temperature, the PTC structure blocks or reduces the current flow and thus may prevent battery rupture.

According to the present invention, the battery protection circuit module 300 is implemented by packaging the battery protection circuit 10 of FIG. 5 which includes the external connection terminals P+, P−, and TH, and the internal connection terminals B+and B−. For example, the battery protection circuit module 300 may be implemented by encapsulating and packaging passive elements (e.g., the resistors R1, R2, and R3, the varistor V1, and the capacitors C1 and C2), the protection IC 120, the dual FET chip 110, and the PTC structure PTC with an encapsulant M.

The above-described battery protection circuit 10 according to an embodiment of the present invention is merely an example, and the configuration, number, or positions of a protection IC, FETs, or passive elements are appropriately variable depending on the function of the battery protection circuit 10. For example, in the battery protection circuit module 300, the dual FET chip 110 and the protection IC 120 may be stacked on one another or may be provided adjacent to each other. Specifically, the protection IC 120 may be stacked on a top surface of the dual FET chip 110, or the dual FET chip 110 may be provided adjacent to a left or right side of the protection IC 120.

As described above, in the polymer battery cell 700 according to an embodiment of the present invention, a protection IC, FETs, and passive elements may be mounted on a PCB. However, the following description is focused on a case in which the protection IC, the FETs, and the passive elements are mounted on a lead frame other than a PCB. In embodiments of the present invention, a lead frame is a metal frame on which lead terminals are patterned, and may differ from a PCB in which a metal wiring layer is provided on an insulating core, in terms of structures or thicknesses thereof.

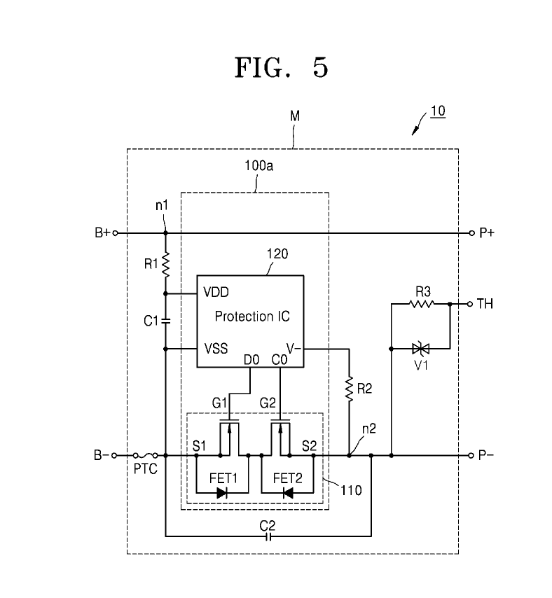

FIG. 6 is a perspective view showing the structure of a lead frame 50 and battery protection circuit elements included in the battery protection circuit module 300 of the polymer battery cell 700, according to an embodiment of the present invention.

Referring to FIGS. 1 and 6, the battery protection circuit module 300 includes the lead frame 50 including a plurality of leads spaced apart from each other, and bonded and electrically connected to the cell taps 760, the battery protection circuit elements mounted on the lead frame 50, and an encapsulant 250 for encapsulating the battery protection circuit elements to expose a part of the lead frame 50. The battery protection circuit elements include a stacked structure 100a of a protection IC and FETs, and one or more passive elements 130. The battery protection circuit elements may further include a PTC structure 350. The PTC structure 350 may be an element produced by dispersing conductive particles in a crystalline polymer.

In the polymer battery cell 700 according to an embodiment of the present invention, the lead frame 50 of the battery protection circuit module 300 may include a first internal connection terminal lead B+ and a second internal connection terminal lead B− provided at two edges, exposed by the encapsulant 250, and electrically connected to the positive and negative taps 762 and 764, respectively, external connection terminal leads provided between the first and second internal connection terminal leads B+ and B− and serving as a plurality of external connection terminals, and element mounting leads provided between the first and second internal connection terminal leads B+ and B− and used to mount the battery protection circuit elements 100a, 130, and 350 thereon.

A top surface of the lead frame 50 may be used to mount the battery protection circuit elements 100a, 130, and 350 thereon, and a bottom surface of the lead frame 50 may be a surface opposite to the top surface. A part of the bottom surface of the lead frame 50 corresponding to an external connection terminal area may be entirely or partially plated. A plating material may include at least one selected from the group consisting of gold, silver, nickel, tin, and chromium.

Although the battery protection circuit module 300 of the polymer battery cell 700 according to an embodiment of the present invention includes the lead frame 50 having a plurality of mounting leads spaced apart from each other, since a battery protection circuit is configured by providing electrical connection members such as bonding wires or bonding ribbons on the lead frame 50, a process of designing and manufacturing the lead frame 50 for configuring the battery protection circuit may be simplified.

In the battery protection circuit module 300 of the polymer battery cell 700 according to an embodiment of the present invention, a protection IC chip and/or a FET chip may not be inserted and fixed into the lead frame 50 in the form of a semiconductor package but may be mounted and fixed onto at least a part of the surface of the lead frame 50 using surface mounting technology in the form of a chip die not encapsulated with an encapsulant but sawed on a wafer. Herein, the chip die refers to an individual structure not encapsulated with an encapsulant but implemented by performing a sawing process on a wafer having an array of a plurality of structures (e.g., the protection IC chip and the FET chip) thereon. That is, when the protection IC chip and/or the FET chip are mounted on the lead frame 50, since the protection IC chip and the FET chip are mounted in a non-encapsulated state and then are encapsulated with the encapsulant 250 in a subsequent process, only one encapsulation process is necessary to implement the battery protection circuit module 300. On the contrary, when the protection IC chip and/or the FET chip are inserted and fixed or mounted into a PCB, since each component initially requires a molding process and then additionally requires another molding process after being fixed or mounted into the PCB, a manufacturing process is complicated and manufacturing costs are high.

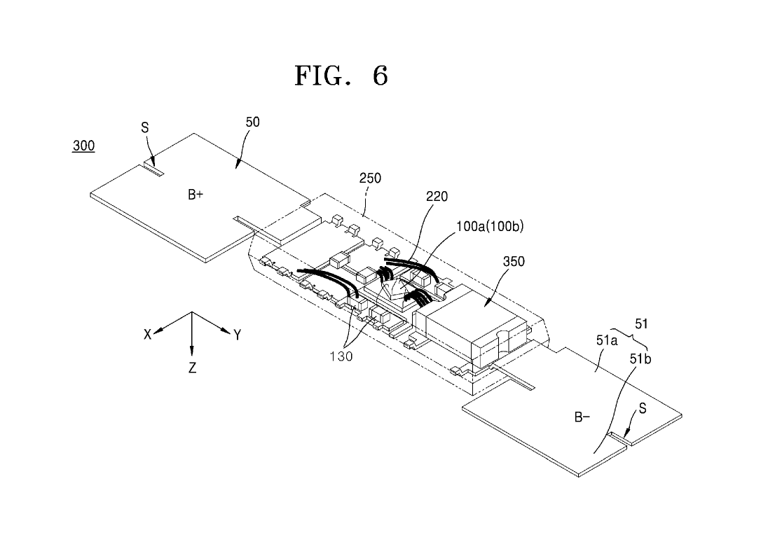

FIGS. 7A and 7B are perspective views showing that internal connection terminal leads 51 included in the battery protection circuit module 300 of the polymer battery cell 700 are folded, according to an embodiment of the present invention.

Referring to FIGS. 5, 6, 7A, and 7B, in the battery protection circuit module 300 of the polymer battery cell 700 according to an embodiment of the present invention, each of the first and second internal connection terminal leads B+ and B− may be folded about a predetermined virtual axis located in the first and second internal connection terminal leads B+ and B−. For example, the internal connection terminal leads 51 may be folded about a predetermined virtual axis (e.g., a virtual axis parallel to the X axis) located in the internal connection terminal leads 51 in such a manner that first parts 51a and second parts 51b of the internal connection terminal leads 51 contact or face each other. Although FIGS. 7A and 7B illustrate that the second parts 51b of the internal connection terminal leads 51 are bent by 90° to form a right angle with the first parts 51a, the second parts 51b of the internal connection terminal leads 51 may be bent and folded by 180° to contact or face the first parts 51a.

Each of the first and second internal connection terminal leads B+ and B− may include a slit S (see FIG. 6) provided along the folding axis in such a manner that each of the first and second internal connection terminal leads B+ and B− is foldable.

The first and second internal connection terminal leads B+ and B− may be easily bent and folded using the slits S provided in the first and second internal connection terminal leads B+ and B−.

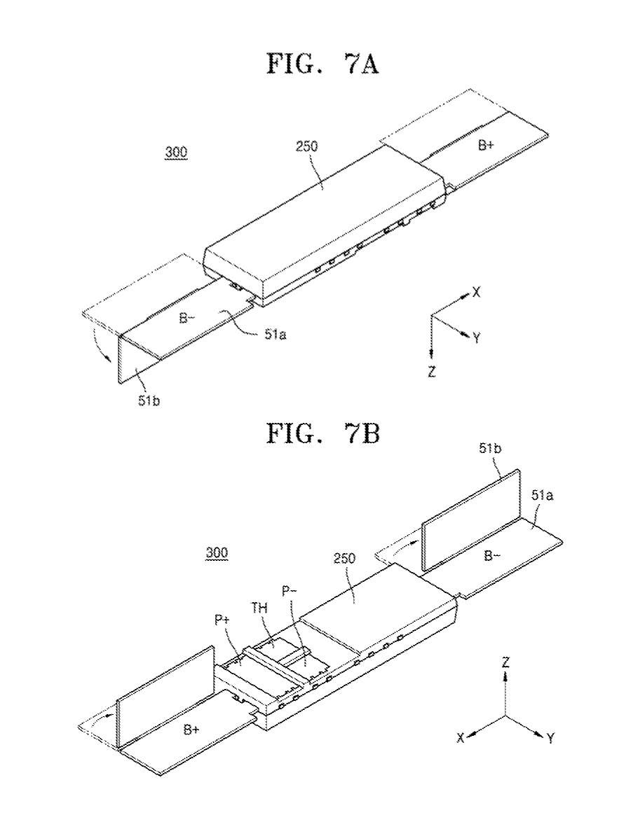

FIG. 8 is a perspective view of a battery protection circuit module assembly included in the polymer battery cell 700, according to an embodiment of the present invention.

Referring to FIG. 8, the battery protection circuit module assembly includes the above-described battery protection circuit module 300 and the FPCB 400 bonded and electrically connected to the battery protection circuit module 300. As described above in relation to FIGS. 1 and 2, the FPCB 400 includes the resin part 420 having flexibility, and the conductive terminal 460 provided at an end of the FPCB 400. An end of the FPCB 400 is bonded and electrically connected to the battery protection circuit module 300, and another end thereof exposes the conductive terminal 460.

Specifically, the lead frame 50 of the battery protection circuit module 300 (e.g., the first to third external connection terminal leads P+, TH, and P− of the battery protection circuit module 300) may be bonded and electrically connected to the conductive terminal 460 provided at an end of the FPCB 400, using at least one method selected from the group consisting of laser welding, resistance welding, soldering, conductive adhesive, and conductive tape. FIG. 8 illustrates soldering as an example. Another end of the FPCB 400 may expose the conductive terminal 460 to be directly and electrically connected to the main board 880 (see FIG. 4).

In the above-described battery protection circuit module assembly, the battery protection circuit module 300 and the end of the FPCB 400 bonded to the battery protection circuit module 300 are accommodated in the pouch 710. Meanwhile, the other portion of the resin part 420 of the FPCB 400 and the conductive terminal 460 are exposed outside the pouch 710.

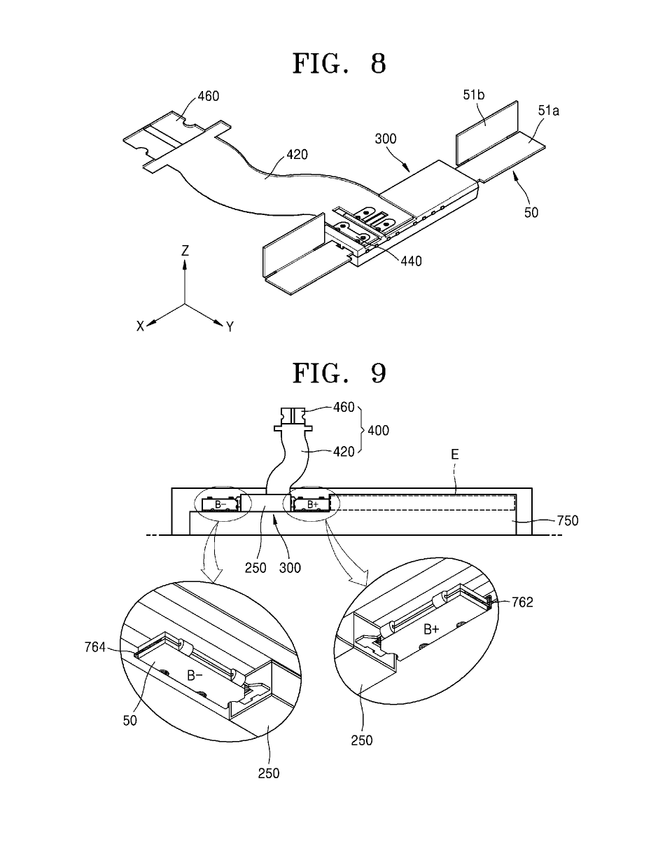

FIG. 9 is a perspective view showing that the internal connection terminal leads 51 included in the battery protection circuit module 300 of the polymer battery cell 700 are folded and bonded to the cell taps 760, according to an embodiment of the present invention.

Referring to FIGS. 8 and 9, the second parts 51b of the internal connection terminal leads 51, which are bent by 90° to form a right angle with the first parts 51a as illustrated in FIGS. 7A and 7B, may be further bent and folded by 180° to contact or face the first parts 51a of the internal connection terminal leads 51 in such a manner that the cell taps 760 including the positive and negative taps 762 and 764 are provided therebetween. In this case, the first and second parts 51a and 51b of the internal connection terminal leads 51 may be bonded to the cell taps 760 using at least one method selected from the group consisting of laser welding, resistance welding, soldering, conductive adhesive, and conductive tape.

A polymer battery cell having a battery protection circuit module accommodated in a pouch, and an electronic device including the polymer battery cell have been described above. According to the above descriptions, since a battery protection circuit module is accommodated inside using a polymer cell having a high degree of freedom in shape, cell capacity may be maximized.

According to embodiments of the present invention, since a battery protection circuit module is accommodated in a pouch instead of using cell taps protruding outside and spot-bonded to connection terminals of the battery protection circuit module, the length of the cell taps may be reduced and the efficiency of using a device space may be increased. In addition, according to embodiments of the present invention, since an extra space generated after the battery protection circuit module is accommodated inside is used, cell capacity may be increased. Furthermore, according to embodiments of the present invention, since the battery protection circuit module is not exposed outside and is accommodated inside, the battery protection circuit module may be protected from an external environment.

While the present invention has been particularly shown and described with reference to embodiments thereof, it will be understood by one of ordinary skill in the art that various changes in form and details may be made therein without departing from the spirit and scope of the present invention as defined by the following claims.

1. A polymer battery cell comprising:
an electrode body comprising a positive plate, a negative plate, and a separator provided between the positive and negative plates;
cell taps comprising a positive tap connected to and protruding from the positive plate, and a negative tap connected to and protruding from the negative plate;
a battery protection circuit module electrically connected to the cell taps; and
a pouch receiving the electrode body, the cell taps, and the battery protection circuit module therein, and being made of a flexible material.

2. The polymer battery cell of claim 1, wherein the electrode body, the cell taps, and the battery protection circuit module are not exposed outside the pouch and are accommodated in the pouch.

3. The polymer battery cell of claim 1, wherein the battery protection circuit module is provided in a recess of the electrode body.

4. The polymer battery cell of claim 1, wherein the battery protection circuit module is provided at an upper part of the electrode body,
wherein a level of an area of the electrode body where the battery protection circuit module is not mounted is higher than a level of an area where the battery protection circuit module is mounted.

5. The polymer battery cell of claim 1, wherein the battery protection circuit module comprises:
a lead frame comprising a plurality of leads spaced apart from each other, and bonded and electrically connected to the cell taps;
battery protection circuit elements mounted on the lead frame and comprising a protection integrated circuit (IC), field effect transistors (FETs), and passive elements; and
an encapsulant for encapsulating the battery protection circuit elements to expose a part of the lead frame.

6. The polymer battery cell of claim 5, wherein the lead frame comprises:
a first internal connection terminal lead and a second internal connection terminal lead provided at two edges, exposed by the encapsulant, and electrically connected to the positive and negative taps, respectively;
external connection terminal leads provided between the first and second internal connection terminal leads and serving as a plurality of external connection terminals; and
element mounting leads provided between the first and second internal connection terminal leads and used to mount the battery protection circuit elements thereon.

7. The polymer battery cell of claim 6, wherein the first internal connection terminal lead is folded and thus two parts thereof are bonded to each other in such a manner that the positive tap is provided between the two parts, and
wherein the second internal connection terminal lead is folded and thus two parts thereof are bonded to each other in such a manner that the negative tap is provided between the two parts.

8. The polymer battery cell of claim 1, wherein the battery protection circuit module comprises:
a lead frame and a printed circuit board (PCB);
battery protection circuit elements mounted on the PCB and comprising a protection IC, FETs, and passive elements; and
an encapsulant for encapsulating the battery protection circuit elements.

9. The polymer battery cell of claim 1, further comprising a flexible printed circuit board (FPCB) having an end bonded and electrically connected to the battery protection circuit module, and another end for exposing a conductive terminal,
wherein the conductive terminal is exposed outside the pouch.

10. An electronic device comprising:
an electrode body comprising a positive plate, a negative plate, and a separator provided between the positive and negative plates;
cell taps comprising a positive tap connected to and protruding from the positive plate, and a negative tap connected to and protruding from the negative plate;
a battery protection circuit module electrically connected to the cell taps;
a pouch used to accommodate the electrode body, the cell taps, and the battery protection circuit module therein, and made of a flexible material;
a flexible printed circuit board (FPCB) having an end bonded and electrically connected to the battery protection circuit module, and another end for exposing a conductive terminal; and
a main board directly and electrically connected to the conductive terminal.
